(19) United States
(12) Patent Application Publication
(10) Pub. No.: US 2005/0238155 A1
(43) Pub. Date: Oct. 27, 2005

(54) Providing information on services in a communication system

(75) Inventors: Marko Siiskonen, Nokia (FI); Martti Ylikoski, Helsinki (FI); Esko Teerilahti, Nokia (FI); Jari Liimatainen, Nokia (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/873,465

(22) Filed: Jun. 23, 2004

(30) Foreign Application Priority Data
Apr. 23, 2004 (FI) 20040575

(51) Int. Cl. H04M 1/64; H04M 3/42

(52) U.S. Cl. 379/201.01

(57) ABSTRACT

A method provides information on services in a communication system. The method includes obtaining information on services provided via the communication system. The method also includes receiving a request for a service from user equipment. The method also includes verifying, using the information, whether the service is available for the user equipment at a predetermined level. The method also includes performing a further action based on a result of the step of verifying. Furthermore, a service analyzer and a portal are configured to execute the method.

### FIELD OF THE INVENTION

The invention relates to communication systems, and more particularly to providing information on services in a communication system. In particular, the invention relates to providing information on external services, the external services being provided by a service provider not comprised in said communication system.

### BACKGROUND OF THE INVENTION

A communication system can be seen as a facility that enables communication sessions between two or more entities such as user terminal and/or other nodes associated with the communication system. Subscribers, such as the users or end-users, to a communication system may be offered and provided numerous services, such as two-way or multi-way calls, data communication or multimedia services or simply an access to a network, such as the Internet.

Examples of communication systems may include fixed line communication systems, such as a public switched telephone network (PSTN), wireless communication systems, e.g. general packet radio service (GPRS), universal mobile telecommunications system (UMTS), wireless local area network (WLAN) and so on, and/or other communication networks, such as an Internet Protocol (IP) network and/or other packet switched data networks. Various communication systems may simultaneously be concerned in a connection. An end-user may access a communication network by means of any appropriate user equipment (UE), for example a mobile terminal, such as a mobile station (MS), a cellular phone, a personal digital assistant (PDA) or the like, or other terminals, such as a personal computer (PC), or any other equipment operable according to a suitable network protocol, such as a wireless applications protocol (WAP) or a hypertext transfer protocol (HTTP). The user equipment may support, in addition to call and network access functions, other services, such as short message service (SMS), multimedia message service (MMS), electronic mail (email), Web service interface (WSI) messaging and voice mail.

It is expected that the number of services provided to users, in particular to mobile users, for example over Internet Protocol Multimedia Subsystems (IMS), may increase strongly. The quality of service, such as the availability or response times of services, may be considered as an important issue. Service quality should be high allowing reliable and continuous, preferably round-the-clock access to services. In practice, this may be difficult or even impossible, as a high number of different size entities, such as small, medium and large companies, may be offering services. Such entities may have widely varying—resources and capabilities for providing services. However, for an end-user, an operator of the network may seem to be the provider of the offered services.

Furthermore, it may be possible that the network operator acts as a service provider towards the end-user, but actually purchases services from an external service provider. This may be referred to as subcontracting.

If the offered services are not available or do not function, end-users may tend to contact the network operator in both cases described above. The end-users may become frustrated, as there may be no indication of a cause or an expected duration of the unavailability.

The network operator, in turn, may not have control over service providers, at least not over all the service providers. Therefore, the situation may be difficult for the network operator and possible actions may be limited. For example, the network operator may discontinue cooperation with unreliable service providers, but such an action may limit service offering.

There is therefore a need for a way of providing information on services in a communication system, in particular information on external services, which are provided by a service provider not comprised in said communication system. The services may need to be monitored, analyzed and/or controlled.

It shall be appreciated that these issues are not limited to any particular communication environment, but may occur in any communication system.

### SUMMARY OF THE INVENTION

Embodiments of the invention aim to address one or several of the above problems or issues.

In accordance with an aspect of the invention, there is provided a method for providing information on services in a communication system. The method comprises obtaining information on services provided via the communication system, receiving a request for a service from user equipment, verifying, using said information, whether the service is available for the user equipment at a predetermined level and performing a further action based on a result of the step of verifying.

In accordance with another aspect of the invention, there is provided a service analyzer entity in a communication system. The service analyzer entity is configured to obtain information on services provided via the communication system, receive a request for a service from user equipment, verify, using said information, whether the service is available for the user equipment at a predetermined level and perform a further action based on a result of the step of verifying.

In accordance with another aspect of the invention, there is provided a portal configured to receive information from a service analyzer entity according to the invention and to display the received information to an end-user.

In accordance with another aspect of the invention, there is provided a computer program comprising program code means for performing any of the steps of the method according to the invention when the program is run on a computing means.

In an embodiment, obtaining information on services may comprise obtaining information on at least one service provided by a service provider external of the communication system. Said information may be obtained by polling predetermined services periodically, by receiving said information from providers of the services, by monitoring traffic between providers of the services and user equipment or by another appropriate method. Information of the services may be stored. In an embodiment, obtaining said information may comprise monitoring quality of the services, such as availability of the services or service response times.

In an embodiment, additional information may be queried from a service provider when a predetermined occurrence is monitored.

In an embodiment, an end-user of the user equipment may be allowed to select a service for subscribing the service. Information of a result of the step of verifying may be provided for displaying in the user equipment.

In an embodiment, it may be verified whether the end-user is entitled to access the service.

In an embodiment, the method may comprise allowing a connection to the service, if the service is available. If the service is unavailable, the method may comprise sending a notification to the user equipment.

In an embodiment, information of the services may be provided to a charging system of the communication system for use in generating charging information. In an embodiment, said obtained information may be provided to providers of the services.

The method may further comprise receiving a monitoring request and adapting the step of obtaining said information in response to the monitoring request.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a flow chart illustrating an embodiment of the invention;

FIG. 3 shows an embodiment of the invention;

FIG. 4 shows a block diagram illustrating an embodiment of the invention;

FIG. 5 shows an example of active monitoring;

FIG. 6 shows an example of passive monitoring;

FIG. 7 shows an example of manual monitoring;

FIG. 8 shows an example of real time monitoring;

FIG. 9 shows an example of data path monitoring;

FIG. 10 shows a further embodiment of the invention;

FIG. 11 shows a further embodiment for providing information;

FIG. 12 shows a further embodiment for providing information;

FIG. 13 shows a further embodiment for providing information;

FIG. 14 shows a further embodiment for providing information; and

FIG. 15 shows a further embodiment for providing information.

### DETAILED DESCRIPTION OF PREFERRED EMBODIMENTS

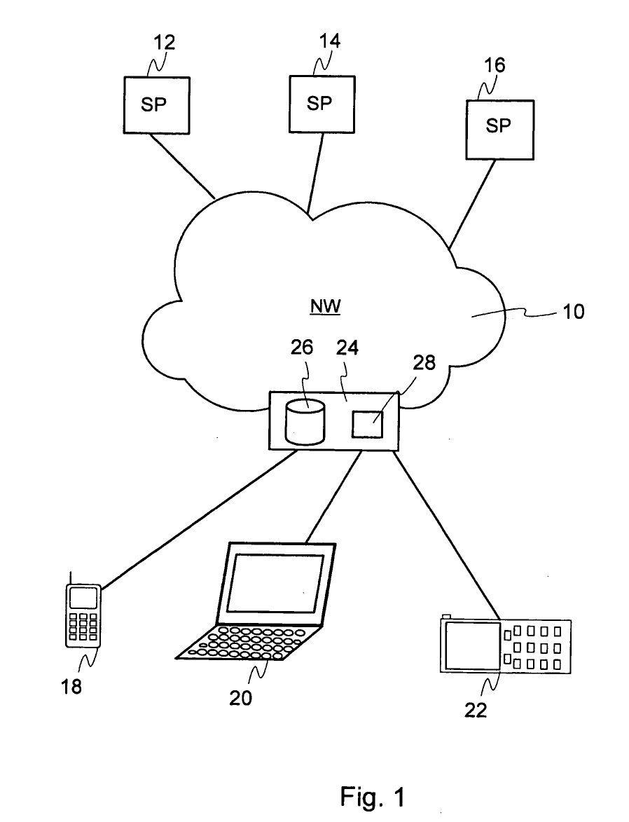

FIG. 1 shows an example of an arrangement including a communication network 10, a plurality of service providers (SP) 12, 14 and 16, and a plurality of user equipment 18, 20 and 22. In connection with the present invention, by service provider it is typically meant a system providing information or any other appropriate form of service provisioning that may occur via a communication network, some examples of which are given above. In the present invention, the service provider may be an external service provider, or in other words, a service provider which is not managed by the operator of the communication network 10. In an embodiment, the service provider may comprise a plurality of servers providing the same service and the servers may locate physically in a single location or in a plurality of locations. The communication network 10 may be any appropriate communication network. In an embodiment, the communication network 10 is provided at least in part by a mobile communication network.

It shall be appreciated that FIG. 1 is only an example showing three external service providers and three user equipment and that the number of these entities may differ substantially from that which is shown. It is also to be noted that a communication network may simultaneously provide services internally and be in contact with external service providers.

An end-user may browse the network and connect the services using an appropriate browser operating according to an appropriate protocol. In a mobile communication network, an example of an appropriate protocol may be the WAP. The communication system may also be provided with some intelligence, an example including, but not limited to, a so-called intelligent content delivery (ICD) system in connection with a mobile communication system.

FIG. 1 shows also a service analyzer entity 24, which may be a separate network element or comprised in the ICD system. The service analyzer entity 24 may be provided with appropriate data storage device 26 for collecting and storing information and processing means 28. Operation of the exemplifying service analyzer entity 24 will become clear from the following description.

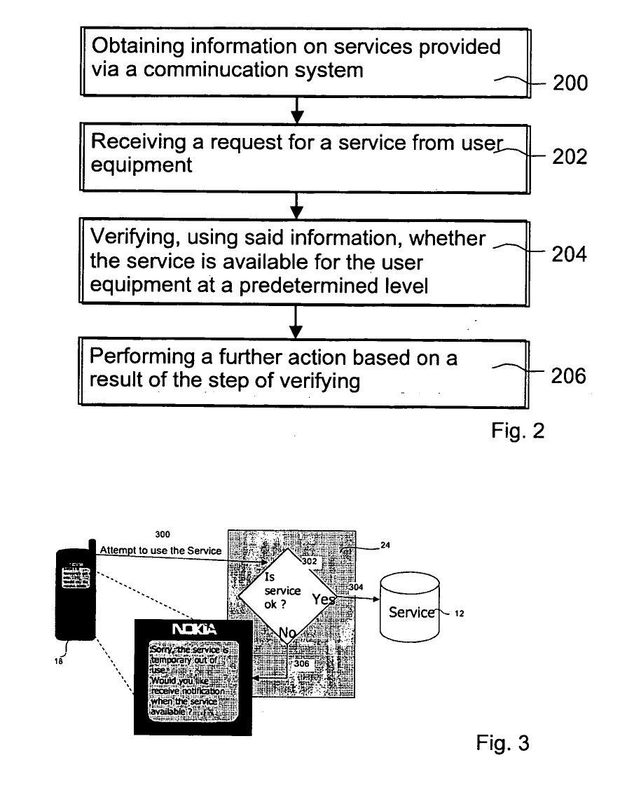

FIG. 2 shows a flow chart of a method for providing information on services in a communication system according to an embodiment of the invention. In step 200, information is obtained on services provided via the communication system. The services may comprise services provided by external service providers, which are not managed by an operator of the communication system, and also services provided by the operator of the communication system. The information may be obtained in various different ways, such as by polling predetermined services periodically, by receiving information from service providers, by monitoring measuring and traffic between services and user equipment and so on. The service analyzer 24 may also receive information on services from separate network elements performing measuring, monitoring and/or analysing even for other purposes in the network.

In step 202, a request for a service is received from user equipment. In step 204, it is verified, using said information, whether the service is available for the user equipment at a predetermined level. The step of verifying may comprise different types of verifications, such as verifying if the service is functioning, if a predetermined quality of service level may be offered, if a user relating to the user equipment is entitled to access the service and so on.

In step 206, a further action is performed based on a result of the step of verifying. If the verifying step shows that the service is available for the user equipment at the predetermined level, the further action may be connecting to the requested service. If the verifying step shows that the service is not available for the user equipment at the predetermined level, the further action may be notifying the user equipment as will be explained in detail below. In an embodiment, the service provider and/or a charging system may be notified.

The method for providing information on services in a communication system may comprise various other steps in further embodiments of the invention. Examples of these steps become apparent from the following description. Steps of the method according to the invention may be carried out in the service analyzer entity 24 or in another appropriate network entity.

The information obtained on the services may be stored in a storing entity, such as the data storage device 26 of FIG. 1. The service analyzer entity may process further the “raw” information obtained for example by polling. Processing may comprise evaluating service quality, e.g. evaluating, calculating or estimating service availability or service response times.

The method may further comprise providing the information obtained on services, and optionally processed further, for displaying to an end-user by means of the user equipment. The end-user may be allowed to select a service for subscribing the service. In response to the selection of the service by the end-user, a connection to the service may be allowed, if the service is available. If the service is unavailable or access of the end-user is not allowed at the moment of the selection, the end-user may be informed when the service becomes available.

The end-user may browse the network via the service analyzer entity 24. When the end-user tries to connect an unavailable service, the service analyzer entity 24 may indicate to the end-user the unavailability of the service as well as other useful information collected and processed by the service analyzer entity 24. The information may be indicated, for example, by means of a message or a dialog.

An example of a dialog is shown in FIG. 3. In step 300, an end-user of user equipment 18 initiates an attempt to use a service 12. In step 302, it is verified, using information obtained in the service analyzer entity 24, whether the service is available for the user equipment at a predetermined level. This verification step may include verifying whether the requested service is available and/or may be offered on a quality level normally expected, for example, in view of information obtained by polling services, measuring path quality, received from service providers and so on. Additionally or alternatively, the verification step may include verifying whether the end-user attempting to use the service is allowed to use the service: for example, has made a service provisioning agreement or has enough payment resources in a prepaid account.

If it is found that the service is available, may be offered with normally expected quality and/or is allowed for the end-user, connection to the service 12 is allowed in step 304. If the verification shows that the service is out of use, cannot be provided with normally expected quality and/or is not allowed to be used by the end-user, a notification may be provided for displaying to the end-user in step 306. The notification may inform the end-user the reason for not allowing a connection. The notification may also include an indication that the end-user shall be informed when the service becomes available. In an embodiment, the end-user may be allowed to choose how the attempt should be treated further. Some other appropriate information may be displayed to the end-user as well.

When the service becomes available, the service analyzer entity 24 may become informed, for example, by the polling carried out by the service analyzer entity 24, itself, or by receiving a notice from the service or by another appropriate way. The service analyzer entity 24 may then forward the information to the end-user. The end-user may be informed, for example, by means of a message sent to the user equipment the end-user used for initiating the attempt to use the service. The end-user may then connect to the service.

The service analyzer entity 24 may also provide information to a service portal displaying the information to the end-user and allowing interactive communication. The service portal may display the whole service offering. The end-user may be allowed to select services to subscribe or to connect. Temporarily unavailable service may be separated from working services, for example, using different colours or other appropriate indication. The end-used may be allowed to connect to an available service. The end-user may be prevented from connecting to the temporarily unavailable services, but the end-user may be allowed to subscribe even such temporarily unavailable services. The service analyzer entity 24 may then inform, for example by means of an SMS or other type of message, the end-user when the service, which the end-user has subscribed in a temporarily unavailable mode, becomes available.

The service analyzer entity 24 may collect service quality information, for example on the response times and on general service availability. The service analyzer entity 24 may process the service quality information further, for example, by calculating or estimating response times and availability of the services or by evaluating the service quality in function of other appropriate measures. The service analyzer entity 24 may also obtain information on quality and capacity or the like relating to paths of the network. Using the path information, the service analyzer entity 24 may estimate or forecast potential problems in connection quality, which the end-user may experience as problems in service quality. Potential problems may arise, for example, in connection with services requiring high capacity if capacity is limited due to peak-hours or for some other reason. Such forecast information may be provided to the end-user also by means of a dialog or a message.

In an embodiment, the user equipment may be provided with said information by means of a machine-readable message, such as a signalling message in accordance with the protocol used in the connection. The machine-readable message may initiate a predetermined action in the user equipment, such as retrying to establish a connection or giving an alarm to the end-user after a period of time indicated in the message.

The service quality information may be provided with a charging system or a service controlling system of the network or directly to providers of the monitored services. The service quality information may be used in generating charging information and in rating. For example, if a content service has been unavailable for a certain period of time or only randomly available, the monthly fee for the content service could be reduced and the end-user might receive a reduced invoice. Embodiments of the invention may be of particular importance and interest in mobile communication systems, as a connection may be chargeable even if a requested service is not functioning. Thus, conventionally the end-user would pay for unsuccessful trying. Collecting service quality information and using such information in charging and rating may provide an incentive for service providers to strengthen the service quality, as the low service quality may result in significant lost in the income of the service provider. Furthermore, the obtained information may be provided to the service providers.

Some of the above-mentioned embodiments and other embodiments of the invention may at least partially be realized in appropriate network elements by means of a computer program. The computer program may comprise program code means for performing steps according to said embodiments when the program is run on a computing means.

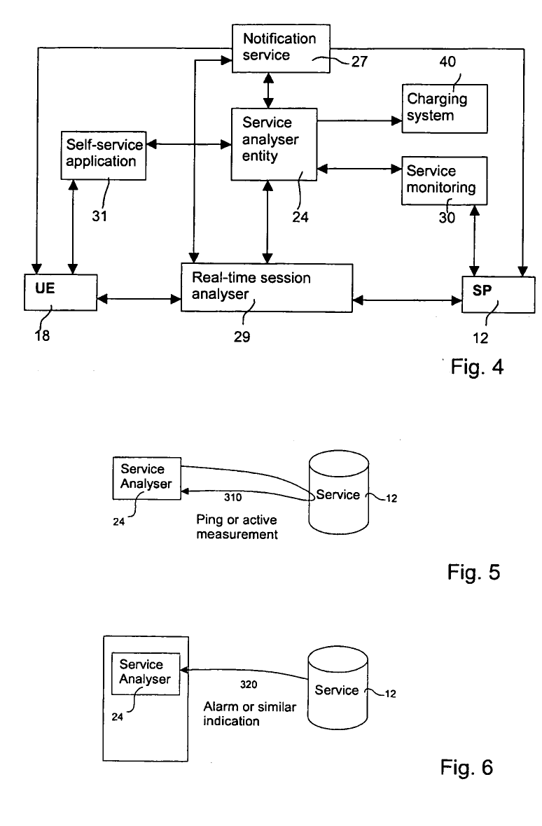

FIG. 4 shows a block diagram illustrating the function of a service analyzer entity 24 in accordance with an embodiment of the invention. A real-time session analyzer 29 may supervise data stream between user equipment 18 and a service 12 and provide information obtained during supervision with the service analyzer entity 24. A service monitoring entity 30 may collect in various ways information on availability, response times, and so on, of services and provide the collected information with the service analyzer entity 24. The service analyzer entity 24 may also receive information, such as reclamations, from end-users by means of a self-service application 31. A notification service 27 may be comprised or connected to the service analyzer entity 24. In response to a predetermined occurrence, the service analyzer entity 24 may enquire from the notification service 27 if particular user equipment or a service has ordered notification service. The notification service 27 may then create and deliver an appropriate notification to the user equipment or the service. Furthermore, a charging system 40 may receive information from the service analyzer entity 24.

The function of the entities shown in FIG. 4 shall be explained further in the following with reference to FIGS. 5-14. It shall be appreciated that FIG. 4 shows only an example of system architecture for an embodiment. Functions of the entities shown may be carried out in a plurality of network entities instead of the one, which is shown. Or, in an alternative, functions of more than one entity as shown may be carried out in a single network entity.

The service analyzer entity 24 may receive monitoring information, for example, via a service monitoring entity 30, which may be a function of the service analyzer entity 24 or a separate network entity. Monitoring may be active as shown in FIG. 5. Active monitoring may comprise sending a ping message or performing active measurements 310 using advanced dialogs pretending real service usage of a service 12. Monitoring may also be passive, as shown in FIG. 6. A failure or a risk of a failure may trigger an alarm or similar one-way indication 320 sent by a service provider or service 12.

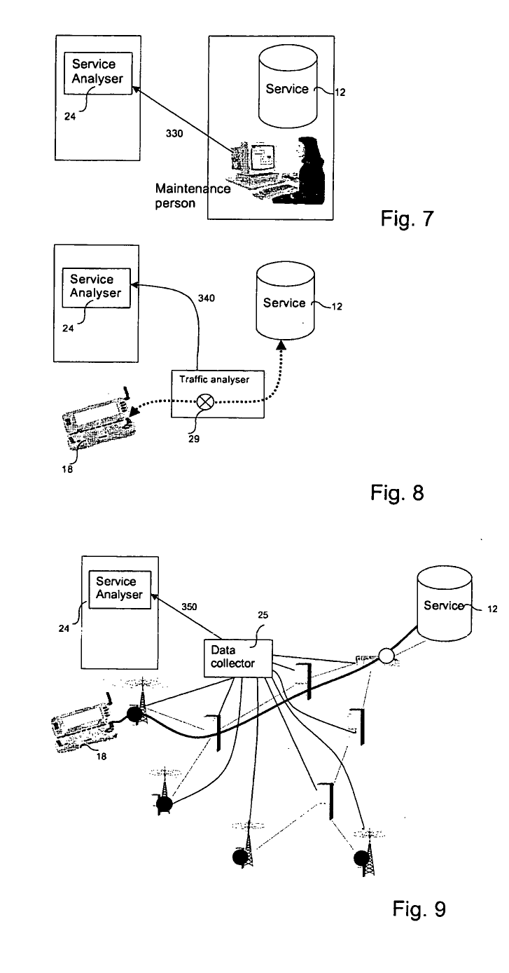

In an embodiment, monitoring may be carried out manually, as shown in FIG. 7. The service analyzer entity 24 or another entity connected with the service analyzer entity 24 may be provided with a function or an interface, which a service provider may use to inform about the unavailability of a service 12, for example by sending an indication 330. In addition to information of a failure or a risk of a failure, or the like, the indication 330 may contain information on when the service is expected to be available again. In particular, manual watching may be useful for receiving information of a planned maintenance break or some other foreseen period of unavailability of the service provisioning.

FIG. 8 shows an embodiment using real time monitoring, where a real-time session analyzer, such as a traffic analyzer 29 supervises data stream between user equipment 18 and a service 12. When the traffic analyzer 29 detects a problem, for example in availability or quality of the service 12, the traffic analyzer 29 may send a report 340 to the service analyzer entity 24.

Monitoring, such as data path availability and quality monitoring, may also be based on measurement data from network elements and on active measurement. The data path between the user equipment 18 end of the data path and the network edge to the service 12 may be monitored in a data collector 25 as shown in FIG. 9. The data collector 25 may send the measurement results 350 to the service analyzer entity 24. The user equipment ends of data paths are shown in FIG. 9 with black dots and the network edge to the service 12 is shown with a white dot. In FIG. 9, only one white dot and four black dots are shown. However, in practice, there are typically multiple user equipment ends and multiple network edges to services.

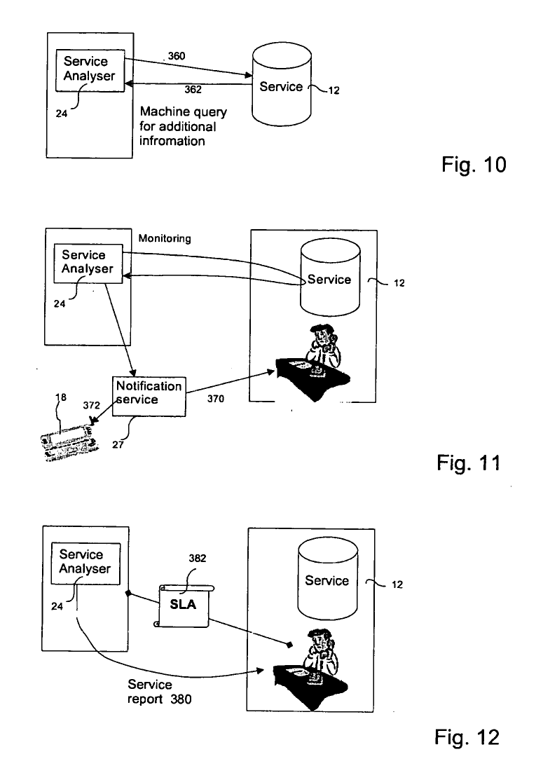

When a problem is recognised in the service analyzer entity 24 relating to a service 12, the service analyzer entity 24 may send a machine query 360 to the service 12, as shown in FIG. 10. The machine query 360 may be used to fetch additional information 362 from the service 12 relating, for example, the nature of the problem or the expected duration of the problem.

FIG. 11 shows an embodiment of notification service. A service provider or an end-user associated with user equipment may request from the service analyzer entity 24, or from another entity receiving information from service analyzer entity 24, notification service 27 relating to the quality of the service or the like. The notification service 27 may comprise sending a message 370 and/or 372 when a failure is detected by means of monitoring, such as active, passive or real time monitoring as explained above, or when a risk of a failure is increasing. The message 370 and/or 372 may be send real-time by means of a notification engine, which may use any appropriate messaging system, such as WSI, SMS, MMS, email, voice mail and so on.

An end-user or a service provider or another party may order notification service, for example, relating to a particular service. The party ordering the notification service may determine conditions for the notification service, such as the service being active for a predetermined period or on a predetermined time of a day, sending a notification for an occurrence determined by the ordering party and so on.

In addition to a message send when a failure or a risk of a failure is detected, the notification service 27 may comprise sending a second message to notify that the requested service is back to use, that the expected service level may now be offered or another such notification. The second message may be send by means of the notification engine. The notification engine has appropriate means for creating messages, such as a computer program or a robot. In an embodiment, manual creation of message may be supported by means of an appropriate interface or the like.

In an embodiment shown in FIG. 12, the service analyzer entity 24 may provide to the service provider a regular service report 380 relating to the service availability and quality. The service report may be based on a service level agreement (SLA) 382 between the service provider 12 and the network operator, for example.

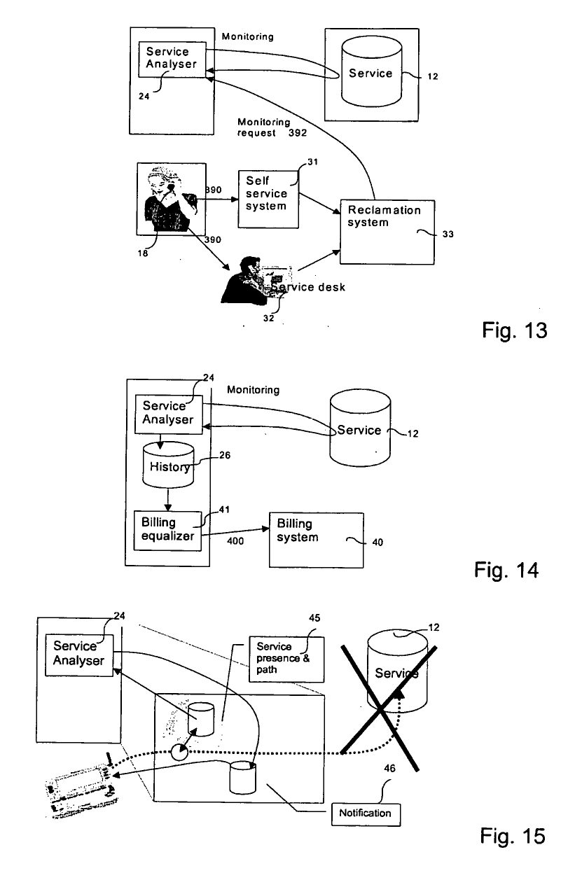

The service analyzer entity 24 may also support a function where user reclamation 390 relating to a service or a similar action initiates or improves, preferably automatically, the monitoring action. An example is shown in FIG. 13. The user reclamation 390 may be received in a reclamation system 33 via a help or service desk 32, a self-service system 31 or another appropriate system. The reclamation system may send a monitoring request 392 to the service analyzer entity 24. Classification, such as a failure probability value, or frequency of the monitoring of the respective service may be adjusted and recommended path from user equipment 18 to the service 12 may be revised in the service analyzer entity 24.

FIG. 14 shows an embodiment providing information for use in a billing or charging system 40 or in another similar system of the network. The service analyzer entity 24 may produce records, based on information obtained in the service analyzer entity 24, for example, by the above-described active, passive or real time monitoring. The records may be stored in a history data repository 26. Information in the history data repository 26 may be used by a billing equaliser function 41 to send a message 400 to the billing system 40. The message 400 may, for example, order to adjust down monthly service fee for a particular user if a particular service 12 has not been available for the user. The billing equaliser function 41 may also be used to correct charging between the network operator and a provider of the service 12 in question, for example, in a case of failures in the availability or quality of a data path or service failures.

FIG. 15 shows an embodiment where a detection function on a user plane is used to trigger if a user tries to use a service, which is under service watching. For triggering function, a service presence and path data repository 45 may locate inside a triggering network element on the user plane or outside the triggering network element. A notification data repository 46 may maintain messages to be presented to the user or to an application in the terminal the user is using for notifying the user. Also the notification data repository 46 may locate inside a triggering network element on the user plane or outside the triggering network element.

Embodiments of the invention may minimize the need of the end-users to contact the network operator thereby reducing the operating expenditure. Embodiments of the invention may also provide a convenient way for end-users to avoid problems caused by unavailability of services. This improves service experience. Embodiments of the invention may provide useful information for network operators and service providers as well.

Although the invention has been described in the context of particular embodiments, various modifications are possible without departing from the scope and spirit of the invention as defined by the appended claims. It should be appreciated that whilst embodiments of the present invention have been described in relation to mobile user equipment such as mobile terminals, embodiments of the present invention are applicable to any other type of user equipment that may access services provided via communication networks. Furthermore, the communication system may be any appropriate communication system, even if reference has mainly been made to mobile communication systems.

1. A method for providing information on services in a communication system, the method comprising:
obtaining information on services provided via a communication system;
receiving a request for a service from user equipment;
verifying, using said information, whether the service is available for the user equipment at a predetermined level; and
performing a further action based on a result of the step of verifying.

2. A method according to claim 1, wherein the step of obtaining information on the services comprises obtaining said information on at least one service provided by a service provider external of the communication system.

3. A method according to claim 1, wherein the step of obtaining said information comprises polling predetermined services periodically.

4. A method according to claim 1, wherein the step of obtaining said information comprises receiving said information from providers of the services.

5. A method according to claim 1, wherein the step of obtaining said information comprises monitoring traffic between providers of the services and the user equipment.

6. A method according to claim 1, further comprising storing said information of the services.

7. A method according to claim 1, wherein the step of obtaining said information comprises monitoring quality of the services.

8. A method according to claim 7, wherein the step of monitoring the quality comprises monitoring availability of the services.

9. A method according to claim 7, wherein the step of monitoring the quality comprises monitoring service response times.

10. A method according to claim 1, further comprising querying additional information from a service provider when a predetermined occurrence is monitored.

11. A method according to claim 1, further comprising allowing an end-user of the user equipment to select the service for subscribing the service.

12. A method according to claim 1, further comprising providing said information of a result of the step of verifying for displaying in the user equipment.

13. A method according to claim 12, wherein the step of verifying comprises verifying whether an end-user is entitled to access the service.

14. A method according to claim 1, wherein the step of performing the further action comprises allowing a connection to the service if the service is available.

15. A method according to claim 1, wherein the step of performing the further action comprises sending a notification to the user equipment if the service is unavailable.

16. A method according to claim 1, further comprising providing said information of the services to a charging system of the communication system for use in generating charging information.

17. A method according to claim 1, further comprising providing said information to providers of the services.

18. A method according to claim 1, further comprising receiving a monitoring request and adapting the step of obtaining said information in response to the monitoring request.

19. A computer program embodied on a computer readable medium, said program configured to control a computer to perform the steps of:
obtaining information on services provided via a communication system;
receiving a request for a service from user equipment;
verifying, using said information, whether the service is available for the user equipment at a predetermined level; and
performing a further action based on a result of the step of verifying.

20. A service analyzer entity in a communication system, the analyzer configured to:
obtain information on services provided via a communication system;
receive a request for a service from user equipment;
verify, using said information, whether the service is available for the user equipment at a predetermined level; and
perform a further action based on a result of the step of verifying.

21. A service analyzer entity according to claim 20, further configured to obtain said information on at least one service provided by a service provider external of the communication system.

22. A service analyzer entity according to claim 20, further configured to poll predetermined services periodically.

23. A service analyzer entity according to claim 20, further configured to receive said information from providers of the services.

24. A service analyzer entity according to claim 20, further configured to monitor traffic between providers of the services and user equipment.

25. A service analyzer entity according to claim 20, further configured to store said information of the services.

26. A service analyzer entity according to claim 20, further configured to monitor quality of the services.

27. A service analyzer entity according to claim 26, further configured to monitor availability of the services.

28. A service analyzer entity according to claim 26, further configured to monitor service response times.

29. A service analyzer entity according to claim 20, further configured to query additional information from a service provider when a predetermined occurrence is monitored.

30. A service analyzer entity according to claim 20, further configured to allow an end-user of the user equipment to select a service for subscribing the service.

31. A service analyzer entity according to claim 20, further configured to provide said information of a result of the step of verifying for displaying in the user equipment.

32. A service analyzer entity according to claim 31, further configured to verify whether an end-user is entitled to access the service.

33. A service analyzer entity according to claim 20, further configured to allow a connection to the service if the service is available.

34. A service analyzer entity according to claim 20, further configured to send a notification to the user equipment if the service is unavailable.

35. A service analyzer entity according to claim 20, further configured to provide said information of the services to a charging system of the communication system for use in generating charging information.

36. A service analyzer entity according to claim 20, further configured to provide said information to providers of the services.

37. A service analyzer entity according to claim 20, further configured to receive a monitoring request and to configure the step of obtaining said information in response to the monitoring request.

38. A service analyzer entity in a communication system, the service analyzer entity comprising:
information obtaining means for obtaining information on services provided via a communication system;
request receiving means for receiving a request for a service from user equipment;
verifying means for verifying, using said information, whether the service is available for the user equipment at a predetermined level; and
action means for performing a further action based on a result of the step of verifying.

39. A portal in a communication system, the portal configured to:
receive information from a service analyzer entity, the service analyzer entity configured to
obtain information on services provided via a communication system,
receive a request for a service from user equipment,
verify, using said information, whether the service is available for the user equipment at a predetermined level, and
perform a further action based on a result of the step of verifying; and
display said information to an end-user.
